(19) United States
(12) Patent Application Publication
(10) Pub. No.: US 2013/0074197 A1
(43) Pub. Date: Mar. 21, 2013

(54) RIGHTS MANAGED DISTRIBUTABLE SOFTWARE

(71) Applicant: Daniel Shelton, Berkshire (GB)

(72) Inventor: Daniel Shelton, Berkshire (GB)

(73) Assignee: Antix Labs Ltd., Berkshire (GB)

(21) Appl. No.: 13/634,721

(22) PCT Filed: May 5, 2010
(86) PCT No.: PCT/EP10/56123

§ 371 Date: Sep. 13, 2012

(30) Foreign Application Priority Data
Jun. 16, 2009 (GB) 0910327.6

(51) Int. Cl. G06F 21/24

(52) U.S. Cl. 726/28

(57) ABSTRACT

A method of distributing rights-managed software makes use of binary portable application components and associated rights components. The application component includes un-encrypted execution code which causes the application component to execute in a restricted mode if either the rights component is missing or if the rights component determines that the relevant licensing conditions are not satisfied. Such an approach allows application components such as games for mobile phones to be distributed freely between users, and to be available for immediate use in a restricted mode without any need for the recipient to contact the rights issuer.

### 1. FIELD OF THE INVENTION

The present invention relates to a method of distributing rights managed software, and to computer readable media carrying such software. It relates in particular, although not exclusively, to software such as computer games which are designed to be exchanged between users of portable devices such as mobile phones, while still being rights managed.

### 2. INTRODUCTION

This document describes a system for the distribution of binary-portable computer software applications and their corresponding digital licenses in such a way that the software application is usable in a restricted manner when a license is not present on the receiving device, and is fully usable when a license is present.

The manner of the restriction of the application's functionality when a license is not present is determined by the software application's publisher or producer, typically in conjunction with the distributor. This may take the form of a time limit or usage limit, disabling certain features of the application, or it could take many other forms.

The digital licenses (“rights components”) take the form of a cryptographically signed piece of data which describes the conditions that are necessary for the license to be valid. These can include locking it to a particular device (or several devices) using unique device identifiers, imposing restrictions on the date range within which the software can be used, limits on the number of times the application can be used, and many other possible conditions. The validity of the rights component is evaluated by the software framework in which the application runs.

This allows a number of use-cases for the software application which are not typically available in digital-rights-management systems that use encryption, where it is generally not possible to access the content unless a valid license (which would usually contain the decryption key) is available.

One example is the “try before you buy” scenario, where the user receives the software application directly from the publisher or an approved third-party and can use the application in a restricted way before choosing whether to purchase a license for the software. “Viral distribution” is another, where end-users can distribute the software application to other end-users, allowing the recipients to access the application in a restricted way, even though the sender may have had a full license for the application.

The invention extends not only to a method of and system for distributing rights managed software, but also to software implementing such a method when stored computer readable media, such as a disc, ROM or RAM. The invention further relates to a mobile device such as a mobile phone which incorporates a system which is arranged to operate such a method.

The invention relies on the combination of a rights management system, the use of cryptographic signatures of the rights information to ensure authenticity, and the use of a binary-portable software delivery format to allow content and rights to be shared across many different types of devices.

In addition, since the system does not rely on encryption of the executable software in its delivery format, the software is usable immediately after being super-distributed, without the requirement to contact the rights issuer but while still retaining control over the use of the software.

The invention may be carried into practice in various ways and several specific embodiments will now be described, by way of example, with reference to the accompanying figures, as follows:

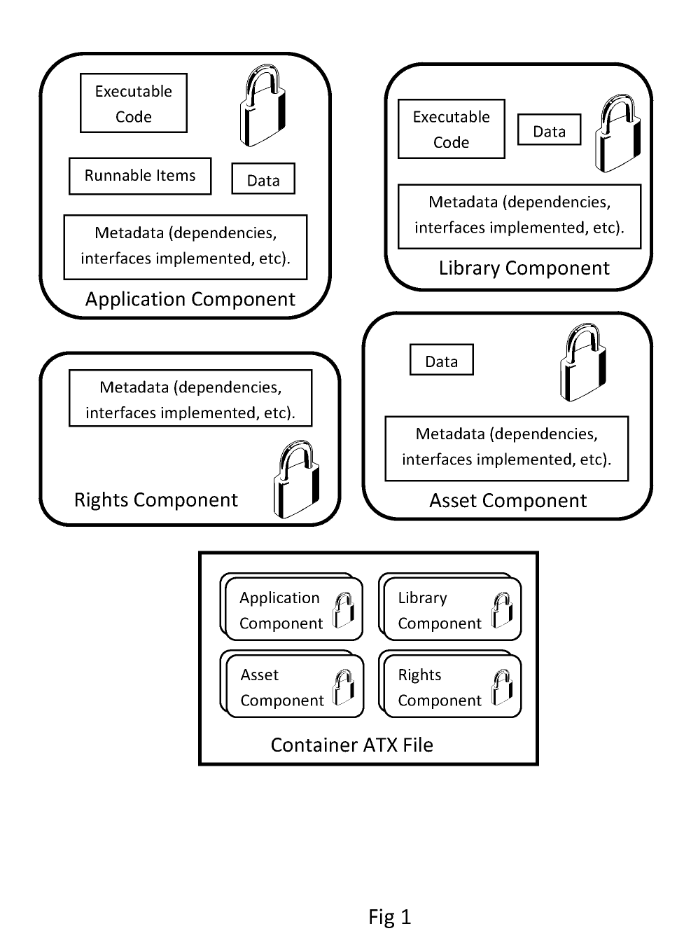

FIG. 1—Distribution file format: Types of ATX file;

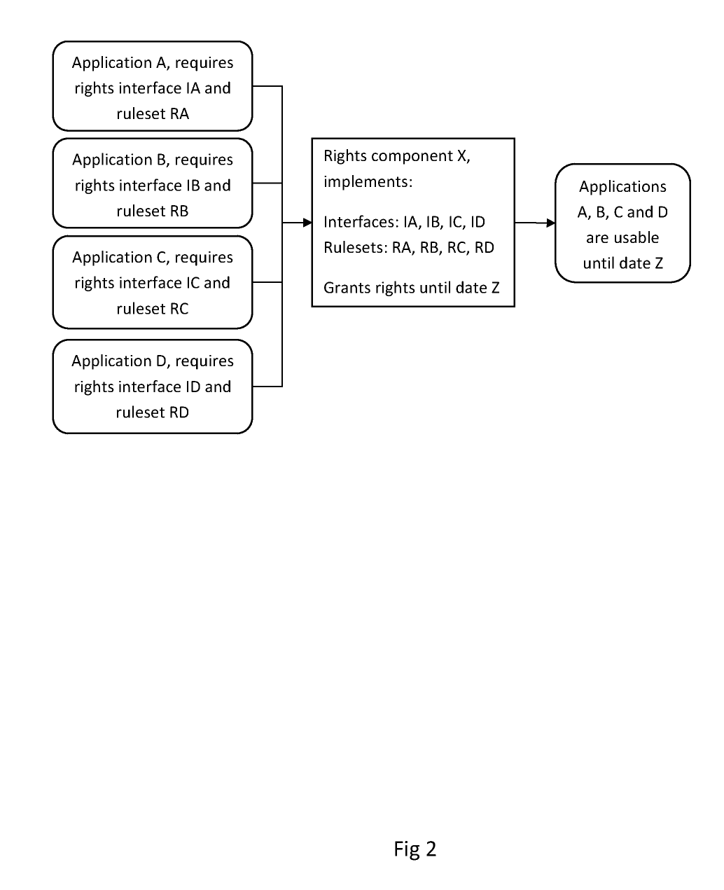

FIG. 2—Operation of DRM system: One rights component granting rights for multiple applications;

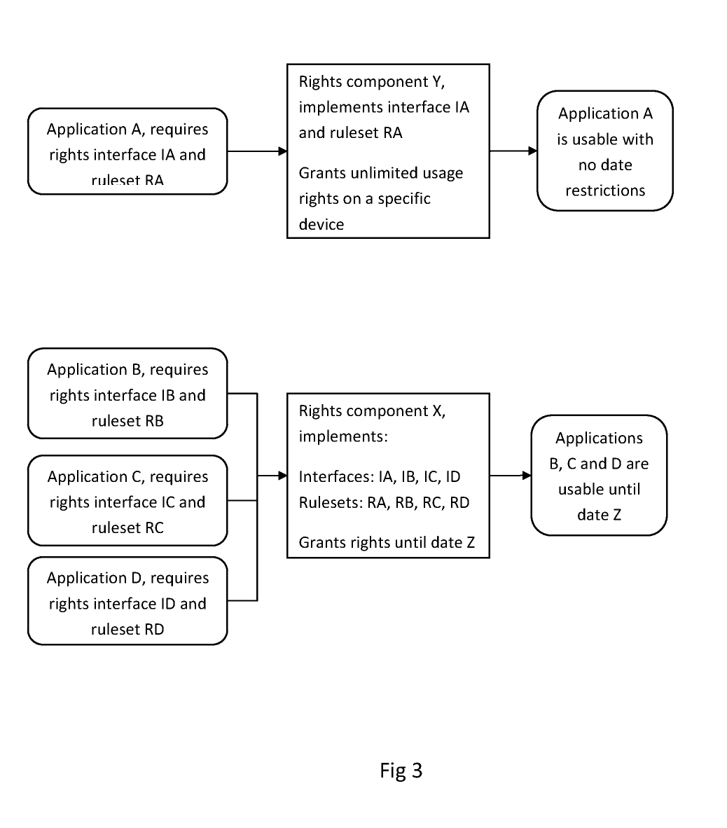

FIG. 3—Operation of DRM system: Multiple rights components implementing the same interface;

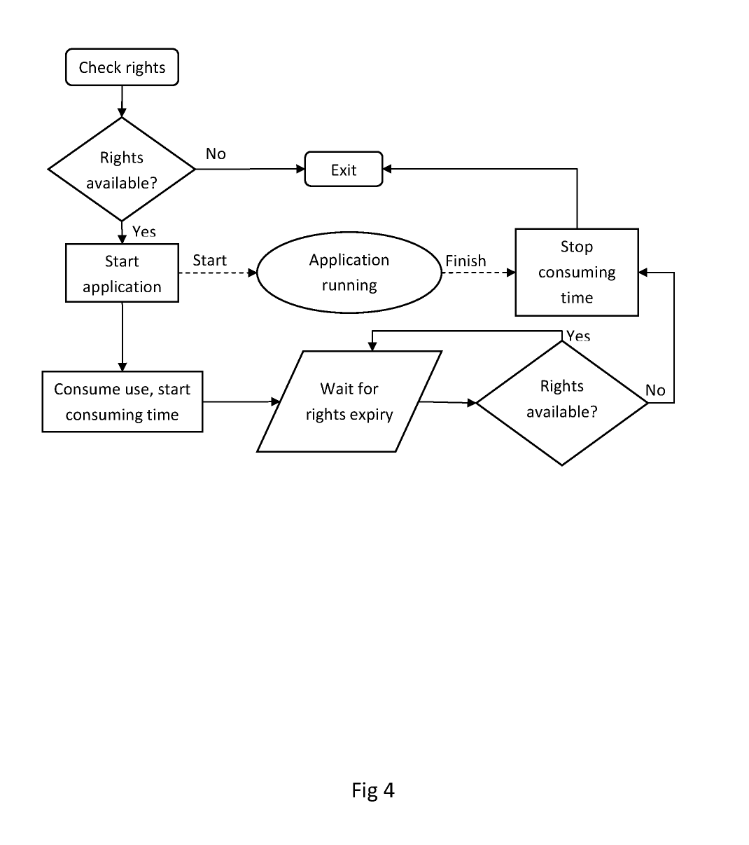

FIG. 4—Rights handling by software environment;

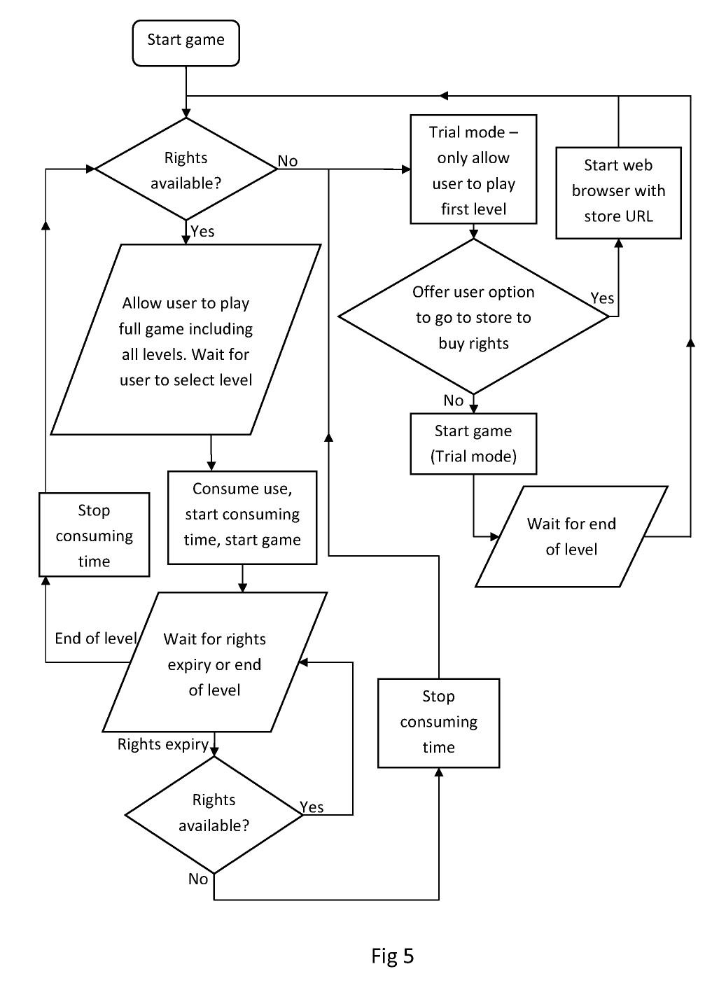

FIG. 5—Rights checking by application, Example 1: Limited Levels Trial Mode

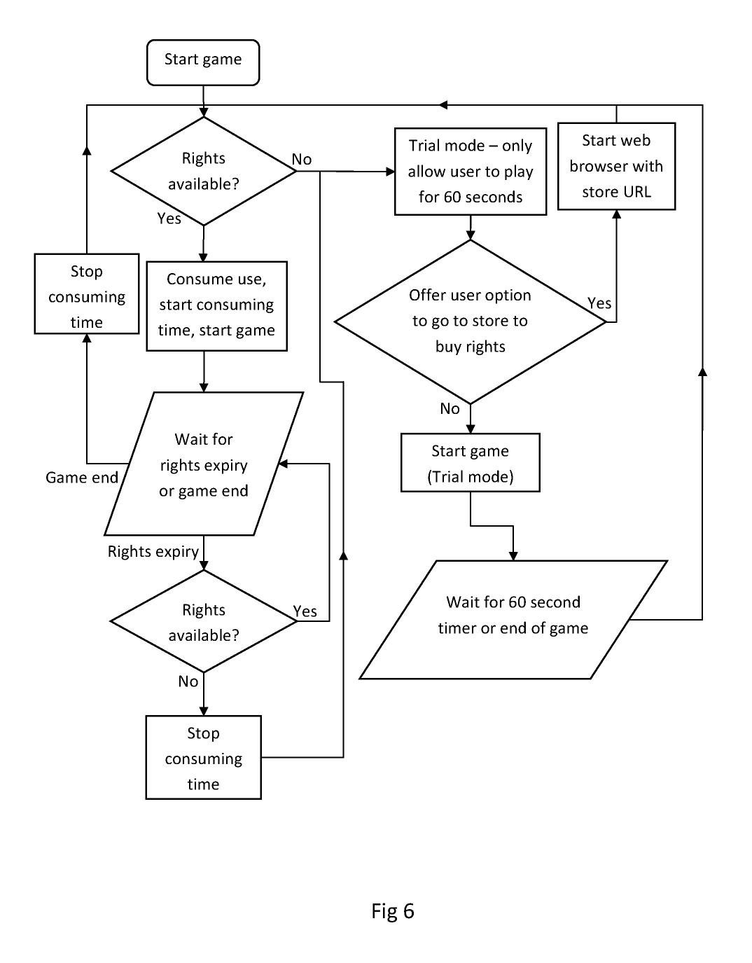

FIG. 6—Rights checking by application, Example 2: Limited Time Trial Mode

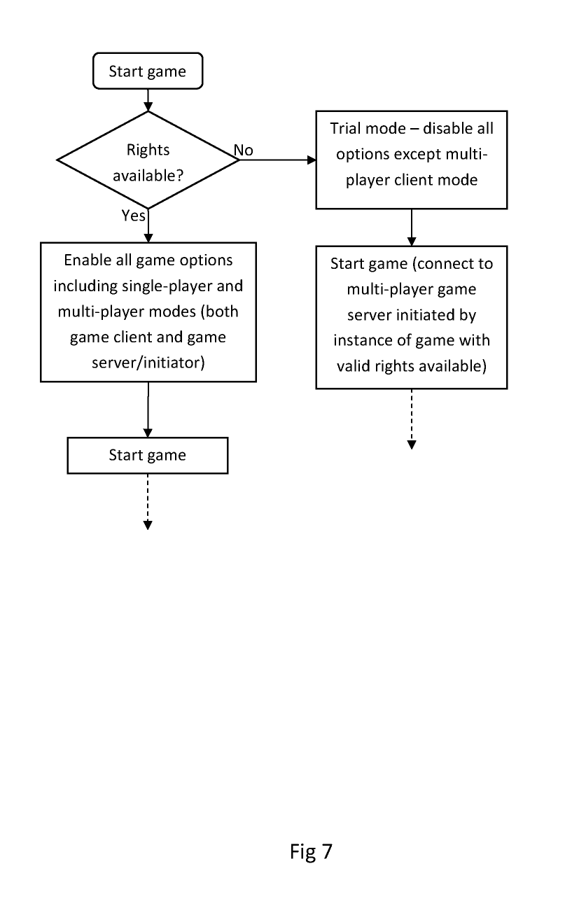

FIG. 7—Rights checking by application, Example 3: Limited Functionality Trial Mode;

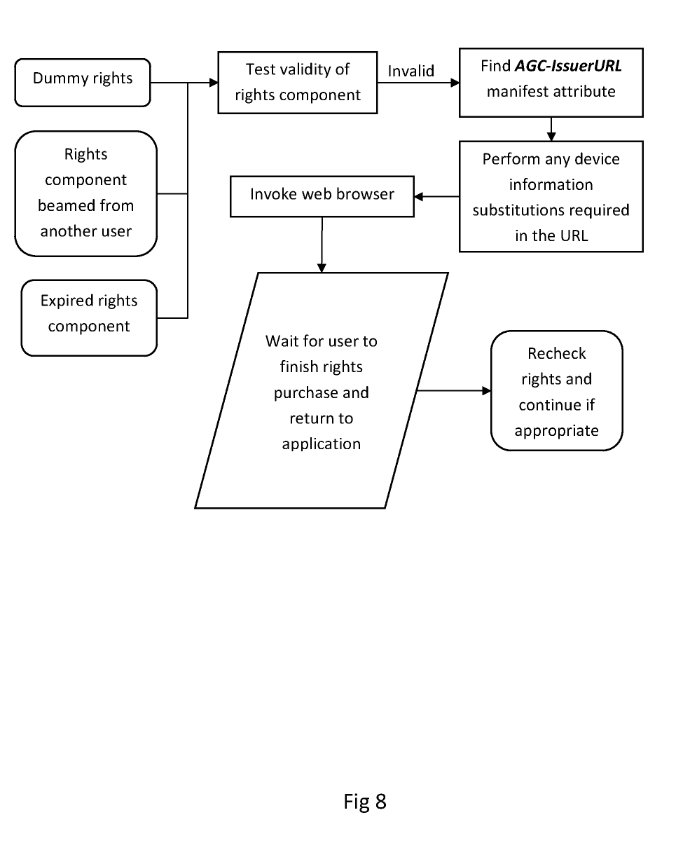

FIG. 8—Rights acquisition: Automatic browser redirection from within application;

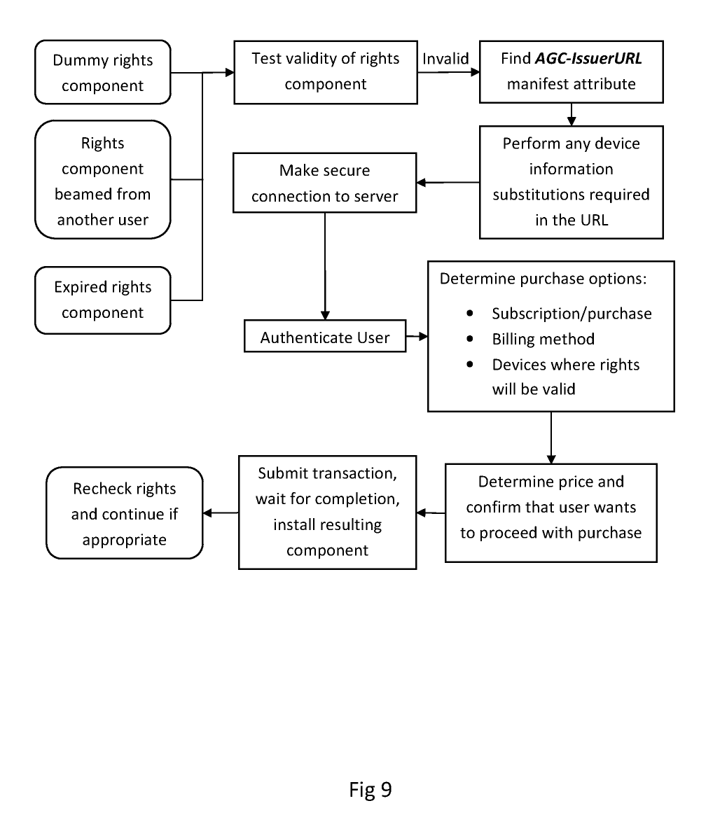

FIG. 9—Rights acquisition: In-application transaction handling;

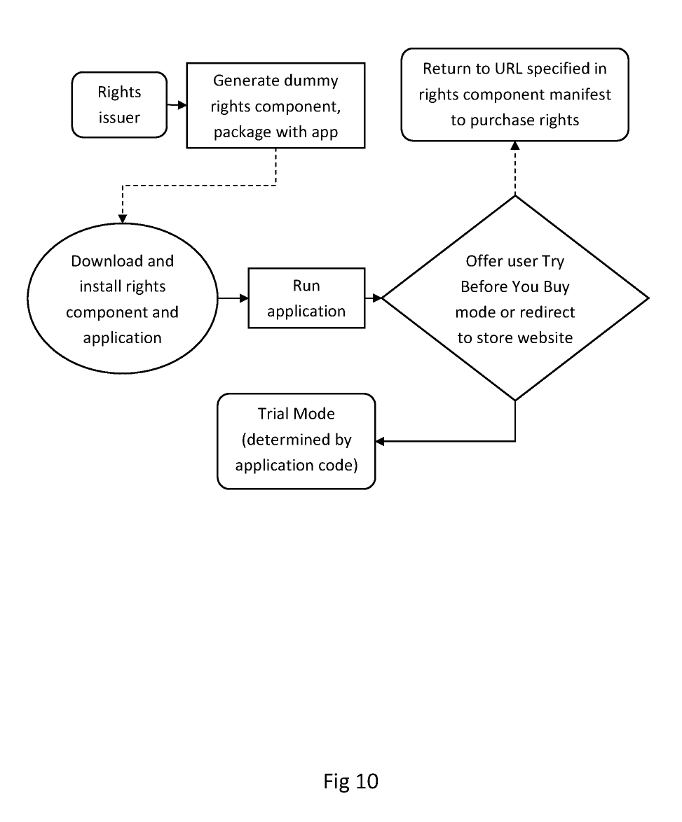

FIG. 10—Rights issuer: Dummy rights component Try-Before-You-Buy;

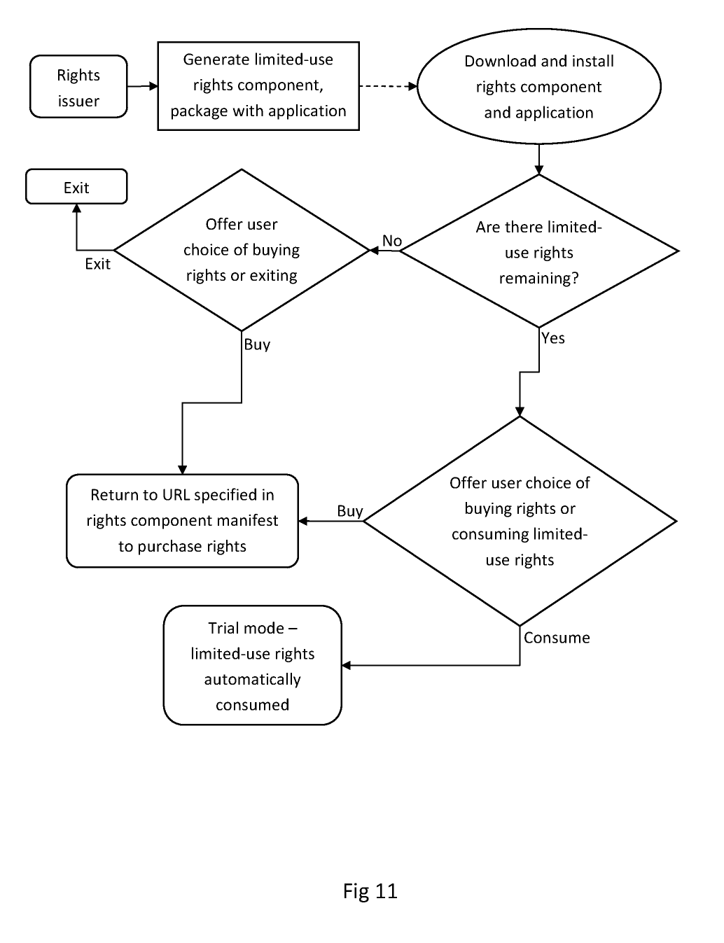

FIG. 11—Rights issuers: Limited-use Try-Before-You-Buy;

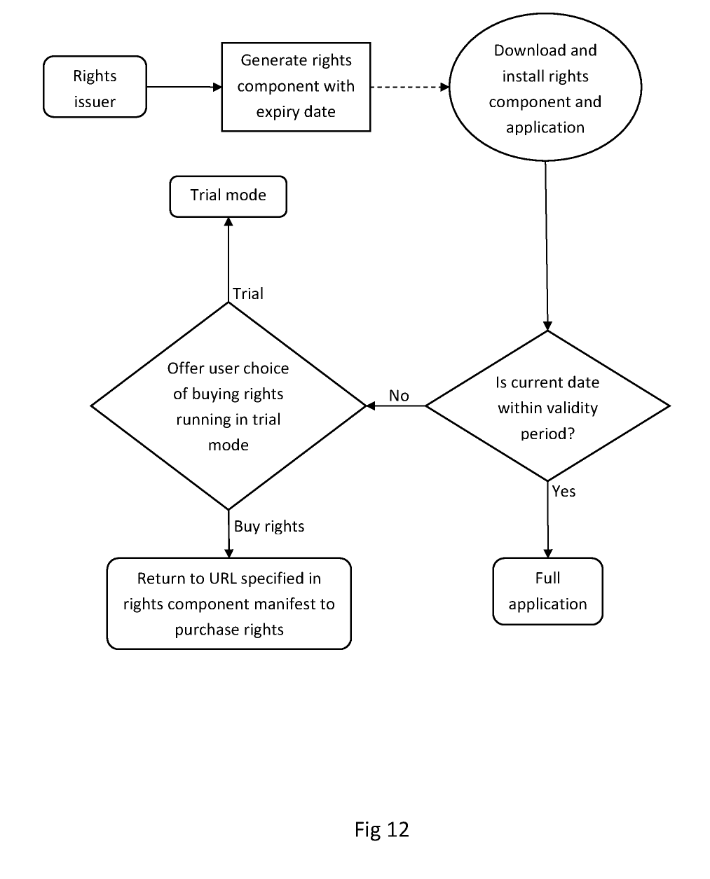

FIG. 12—Rights issuer: Subscription rights;

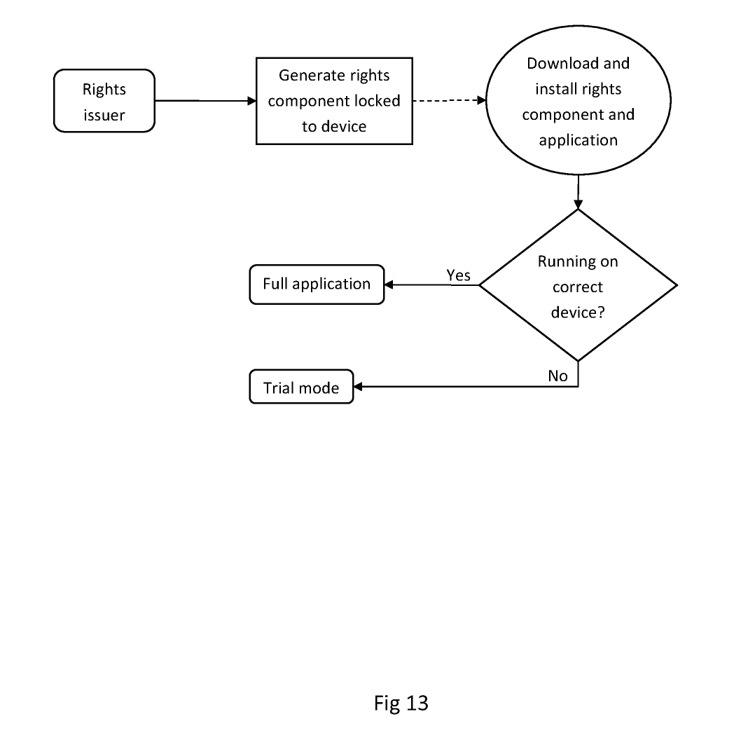

FIG. 13—Rights issuer: Device-locked rights;

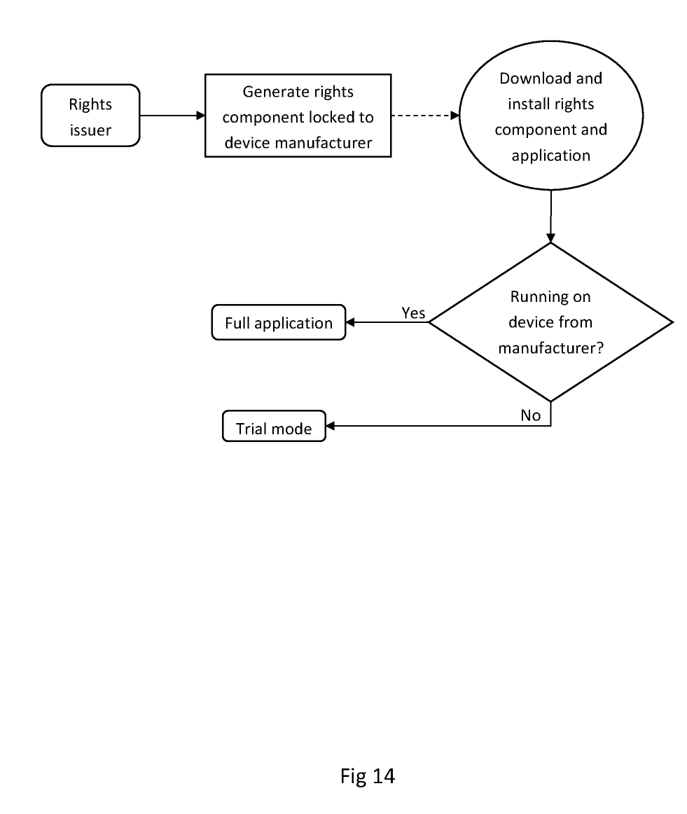

FIG. 14—Rights issuer: Manufacturer locking;

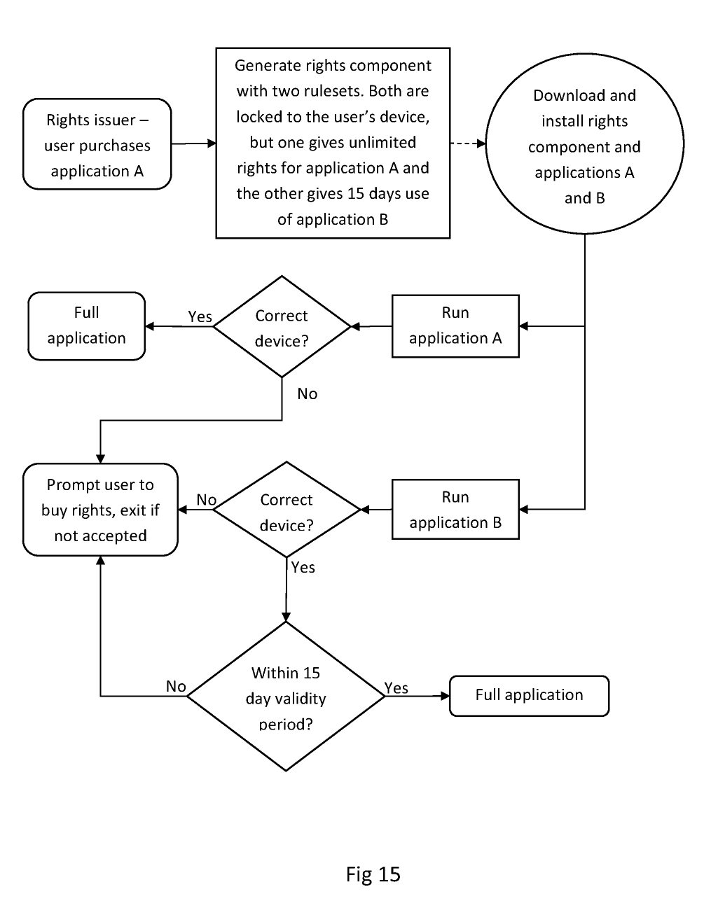

FIG. 15—Rights issuer: Different rights within single rights component; and

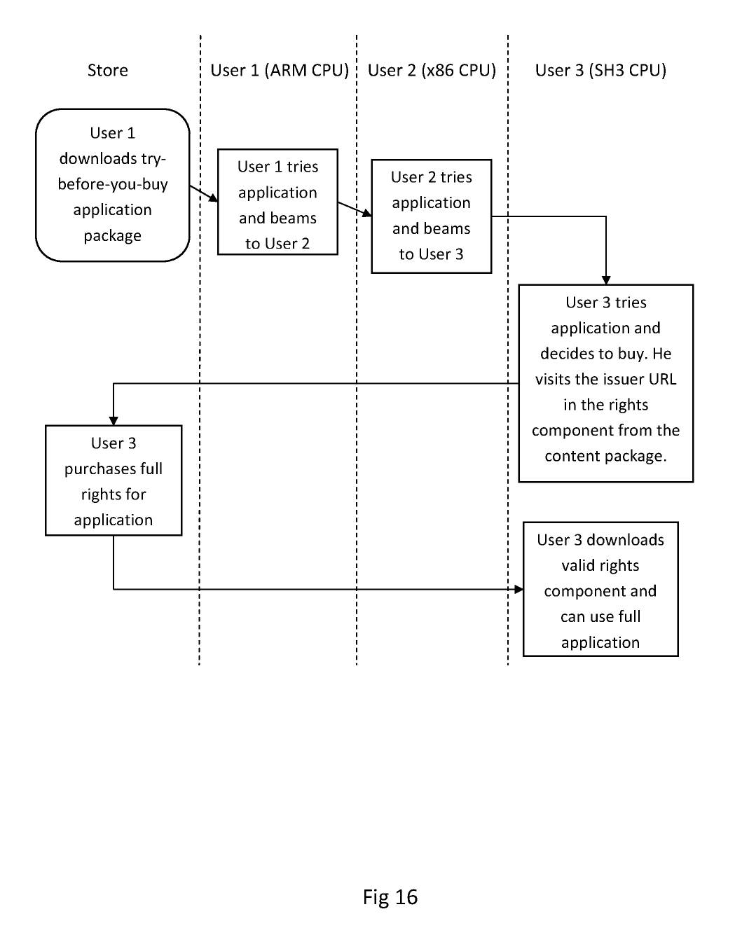

FIG. 16—Viral Distribution across different device types.

### 3. DESCRIPTION

### 3.1 Background

The fields of Digital Rights Management and cryptography are well documented and will not be described in detail here. Background information can be found in the following publications, all of which are incorporated by reference:
RSA cryptographic algorithm: RSA public-key cryptography algorithm: U.S. Pat. No. 4,405,829, Rivest, Shamir & Aldeman, filing date 1977, Dec. 14;
SHA-1 secure hash standard: Secure Hash Standard SHA-1, FIPS PUB 180-1, NIST, 1995;
PKCS#7 cryptographic message format: PKCS#7 Cryptographic Message Syntax, RFC 2315;
X.509 directory, authentication framework: CCITT Recommendation X.509: The Directory—Authentication Framework, 1988;
ASN.1 data format CCITT Recommendation X.208: Specification of Abstract Syntax Notation One, 1988 and CCITT Recommendation X.209: Specification of Basic Encoding Rules for Abstract Syntax Notation One, 1988;
ZIP archive file format: Zip File Format, PKWARE Inc.;
JAR archive file format: JAR File Format, Sun Microsystems, 2004; and
BASE64 encoding format: Base64 Data Encoding Format, RFC 4648.

### 3.2 Distribution File Format

Software content, assets and meta-data are in this embodiment distributed in the “ATX” file format which is an extension to the JAR file format listed above. Other formats could of course be used.

In particular, the ATX file format uses the exact same cryptographic signing mechanism used by Java's “jarsigner” tool, with the restriction that the RSA and SHA-1 algorithms must be used.

ATX files can have two modes:
ATX files can contain application content or meta-data. These ATX files are cryptographically signed to ensure authenticity of the contents. ATX files like this are known as “components”.
ATX files can contain other ATX files. These are not cryptographically signed, although the inner ATX files are signed. This is used to distribute several related ATX files as a single unit without modifying any of them. For example, an application and its corresponding rights components are often distributed in this way. ATX files of the first type (components) can contain executable code, data files for use by the application (such as images, audio files, etc), and meta-data.

Although there is no formal division of these files into different types imposed by the software environment, there are a number of common ways in which these files are used, which leads to an informal classification into a number of types:
Application components. These are components whose primary purpose is to contain a software application. They may also contain data for use by the application. These components have one or more “runnable items”—application programs which are runnable by the end user.
Library components. These are components which contain executable code shared libraries which are useful to applications, but which do not by themselves constitute a useful software application. These components do not contain runnable items.
Asset components. These are components which contain data files for use by a software application. They are not typically useful by themselves. An example of the use of an asset component is a component which contains the data files which define a “level” for a game application. This sort of usage allows games to have additional levels which can be installed separately from the game itself. Asset components may be used by more than one software application.
Rights components. These are components which contain only meta-data in the form of entries in the manifest file, for the purpose of determining whether valid rights are available for other components.

See FIG. 1 for some examples of ATX files.

### 3.3 Component Manifest Headers

As already described, component ATX files have a manifest which contains key/value pairs, as defined in the JAR file specification. In addition to the standard key names defined there, components have a number of additional headers, which specify items such as:
AGC-Component: The component name and version number. A component's name is a URI assigned by the creator. The URI is unique, and can thus be used to unambiguously refer to a particular component.

The version number is simply a 64-bit number (normally expressed as the decimal forms of the two 32-bit parts of this number, separated by a “.” character). There is no specific requirement as to how this number should be assigned, but a common approach is to use the 8 digit representation of the date when the component was created for the top 32-bit value (for example, 20080102 for 2 Jan. 2008) and the 6 digit representation of the time when the ATX file was created for the bottom 32-bit value (for example, 143000 for 2.30 pm). This can easily be automatically generated by build tools when the component is built.

Component version numbers have no semantic meaning other than to determine whether a particular version of a component is newer or older than another.

The combination of a URI and specific version number uniquely identifies an exact ATX file.
AGC-Name: A human-readable name of the component (optional)
AGC-Vendor: The name of the vendor of the component (optional)
AGC-Description-LANG: Zero or more human-readable descriptions of the component in different languages. The string “LANG” in the character name is replaced with a 2 letter country code (as defined in ISO 3166-1) indicating the language.
AGC-InterfaceComponent-N: Zero or more interface names and version numbers which the component implements. An interface in this context is a specification of what a component does or contains (or both). It forms a contract between components which implement that interface and components which make use of the interface.

The N in the manifest header name should be replaced with a numeric index starting at zero.

Interface names are unique URIs similar to component name URIs. Interface version numbers are also 64-bit numbers like component version numbers. However, unlike component version numbers, interface version numbers have semantic meaning beyond simply indicating that a component is newer or older than another—they specify compatibility between different versions of an interface.

This is described in more detail in the section entitled “Component Interface Version Numbering”. A component can implement more than one interface (so long as the interface definitions do not conflict).
AGC-Dependency-N: Where a component requires certain other components to be present, it can express a dependency on them in its manifest. This is done using a URI and a version range which specifies which versions are acceptable. The dependency can be either on a component name or an interface name.

The N in the manifest header name should be replaced with a numeric index starting at zero.

See the section entitled “Component Dependencies” for more details.
AGC-Rule-N: An individual rule which specifies a single Boolean constraint. The “N” in the manifest header name is replaced with an identifier which is unique within the manifest. This identifier is used to refer to the rule in one or more AGC-Ruleset headers.
AGC-Ruleset-M: An expression specifying how rules are to be combined and evaluated to give an overall Boolean result value. The expression includes grouping operators and Boolean operators which form a general expression language in which rules are referred to using their unique identifiers.

The “M” in the manifest header name is replaced with an identifier which is the name of the ruleset.

See the section entitled “Rights Rulesets” for more details.
AGC-Issuer-URL: A URL which can be used to obtain additional rights. This typically exists only in a rights component.
AGC-Item-N: For components which contain an executable program which is runnable in its own right (i.e. not a shared library executable), one or more of these manifest headers is included to specify which executable program should be run, what command-line parameters should be passed to it, and what icon should be displayed to the user.

Several of these headers may be present, and may either refer to different executable programs within the component or to the same executable program with different command-line arguments to control its behaviour.

### 3.4 Component Interface Version Numbering

A component interface is a definition of what a component provides. This may be in terms of files that it contains (for example, an asset component for a game might have data files with particular names), meta-data in its manifest (see the section entitled “Component Dependencies”), or shared libraries having particular APIs.

Interface version numbers specify compatibility between different versions of an interface.

For example, an interface which represents a shared-library with a specific API could change for several reasons, such as:

1. A new function has been added to the API

2. An existing function in the API has been changed in a backward-compatible way

3. An existing function in the API has been changed in an incompatible way

4. The name of the shared library file within the component has changed

As should be obvious from this example, certain types of changes are backward-compatible (1 and 2 in the above list), meaning that a software application which is written to use the old version of the interface will continue to work with an implementation which actually provides a version changed in a backward-compatible way.

Others (such as 3 and 4 in the above list) are incompatible changes, such that software applications expecting an older version of the interface will no longer work correctly after such a change.

The interface version number indicates the compatibility status of different versions of the interface. Changes to the least significant 32-bits of the value indicate backward-compatible changes, and changes to the most significant 32-bits of the value indicate incompatible changes.

Although the example above describes compatible and incompatible types of changes for interfaces with shared-libraries, equivalent scenarios exist for interfaces which specify that data files or meta-data exist in particular formats where the content defined by the interface definition changes.

Components which rely on a particular interface should express the range of version numbers which are acceptable, so that the presence of a valid implementation of the implementation can be ensured by the runtime software environment. See the section entitled “Component Dependencies” for more details.

### 3.5 Component Dependencies

When a component depends on functionality or data in other components, it can use a dependency to ensure that they are present.

It is usually the case that a component requires a specific set of functionality to be present, rather than an exact implementation of that functionality. Where this is the case, dependencies should be on component interfaces rather than on component names.

By using component interfaces, the referring component can specify exactly what version of the interface it requires. For example, for a component containing an executable program which requires another component containing a shared-library, the referring component will typically have been written to use a particular version of that library's API.

In particular, it requires that the features defined in that version of the API are present. However, if there is a more up-to-date version of that interface present, then as long as the newer version is backward-compatible with the version required with the application, the dependency can be considered to be satisfied.

If a newer version of the interface is present which is not backward-compatible, or if an earlier version of the interface which does not contain all of the features requires is present, the dependency cannot be considered to be satisfied.

Similar scenarios exist for asset components and meta-data components, although library components are the most prone to this sort of API change.

Components can specify exactly which versions of an interface they will allow. A component dependency specifies a URI, which is either the URI of a component name or a component interface. In addition, a version range is specified (starting and ending version numbers, with wildcards).

Where the URI is a component name, there is no formal definition for the meaning of the version numbering system, so the only sensible way to specify a range is with knowledge of the behaviour of exact version numbers. This is typically only possible with close co-operation between the producer of the library component and the producer of the application component.

However, where the URI is a component interface name, the referrer can specify the starting version number of the range to be the earliest version of the interface definition where all of the required functionality was available.

The ending version number is typically specified with the same most-significant 32-bits as the starting version number (indicating that interface versions which are not backward compatible with the starting version number are not allowed), and the least significant 32-bits are usually specified with a wildcard (using the ‘*’ character instead of a decimal number), which means that any version number later than the starting version number's least significant 32-bits is acceptable).

This allows components with dependencies on an interface to make use of any component which implements the required version number of that interface or any future version that is backward-compatible with it.

This allows a simple upgrade path for libraries and asset components without requiring synchronisation with application versions.

### 3.6 Rights Rulesets

Several of the manifest headers defined in the ATX file format specification are related to the DRM system: AGC-Rule-N (defining a named rule) and AGC-Ruleset-M (defining a named expression). Rulesets are named expressions which use grouping operators and Boolean operators to combine individual rules into an overall expression.

A manifest may have many rules testing different constraints, and several rulesets which combine these rules in various ways to form particular results.

Rules can test a wide range of different constraints, such as:
Match the device's IMEI, IMSI, ESN or other unique identifier, resulting in a rule which only evaluates to TRUE on certain specific devices
Match the device manufacturer's name
Match the network operator's name
Match the device type
Check that the date is within a specific range
Check that the date is not more than a specific amount of time after the component was installed
Check that the component has not been used more than a specified number of times
Check that the component has not been used for more than a specified amount of time
Evaluate another ruleset in a different component

By combining these rules using Boolean operators and grouping operators into a ruleset, a very flexible system for describing constraints is available.

For DRM purposes, the ruleset named “component_rights” in a component specifies the expression which is evaluated to determine whether the rights for that component are valid.

However, although the software environment which is checking whether rights are valid for a particular component uses the “component_rights” ruleset from that component, the ability for a ruleset to use a rule which evaluates a ruleset in a different component means that this component can in fact delegate the description of some or all of the rights constraints to a separate component which is produced specifically for this purpose—a “rights component”.

This means that the component's manifest does not need to be changed in order for rights to be issued or changed. A rights component can therefore contain rules which are specific to the user who purchased the rights (such as matching a particular device ID), rights can be re-issued when they expire, etc.

### 3.7 Security of Components

The security of components in this system (including rights components) is ensured by verifying the cryptographic signature of the rights component and verifying the certificate chain from the signing certificate to the root certificate.

This validates that the component has not been modified since it was signed.

The security of this system primarily relies on the root certificate and the software program performing the signature validation not being modifiable by an attacker. This is completely dependent on the security model of the underlying operating-system, and so is outside of the scope of this document.

On a secure underlying operating system, one can have a high degree of confidence that the rights system cannot easily be circumvented. On a less secure system there may be attack vectors which can succeed with moderate effort on behalf of the attacker, but this is a property of the underlying operating system and other DRM systems would typically have similar flaws on such systems.

### 3.8 Binary-Portable Software Distribution Format

A key part of this invention is the fact that the application software being distributed is binary-portable. This means that it is not specific to a particular operating-system or CPU type.

This is achieved in the preferred embodiment by deferring the final machine-specific part of source code compilation (primarily this consists of instruction selection and register allocation) until the application software is delivered to the device where it is to be run. Many compilers hold their internal state in a machine-independent format before doing final code generation, so splitting the compilation process at this point is a simple step.

This allows the same application package to be delivered to devices with different CPUs and operating systems, and once translated to native the application runs with a performance level similar to that if it had been compiled for that platform in one operation as normal.

By deferring the machine-specific parts of the compilation until the application is installed on the target device where it will be executing, it is possible to take advantage of features of the specific CPU (hardware floating-point, optimal instruction selection, etc) which are not possible when compiling a program which needs to be binary-portable across a range of similar processors such as the ARM family or x86 family.

This allows native code tailored to the specific CPU variant to be generated, taking advantage of coprocessors, extensions to the instruction set or differences in instruction performance. This can result in significantly higher performance than can be achieved with a lowest-common-denominator CPU family binary.

The concept of distributing intermediate code and performing a final translation to native code later is well known, and has been the subject of many academic papers and patents (for example U.S. Pat. No. 5,280,613, Chan et al: ANDF installer using the HPcode-Plus compiler intermediate language, U.S. Pat. No. 5,586,323: Koizumi, et al: Compiler system using an intermediate abstract form and machine-specific installers), and has also been used in a number of products.

It is the combination of this process with the use of DRM rights as described above which makes possible the novel usage scenarios described here.

### 4. OPERATION OF THE DRM SYSTEM

Application, library and asset components can have a ruleset named “component_rights” in their manifest which specifies the expression to be evaluated to determine the validity of the rights.

It is usually the case that it is not desirable for these components to contain the entire set of rights constraints, as this would mean that in order to lock the component to a particular device it would be necessary to modify its manifest to contain a rule with the relevant device's unique identifier, and then re-sign the component. This has several disadvantages:
When changing the rights, the entire component would need to be downloaded again.
There may be security permissions which are granted to an application based on its signer. This is common in J2ME systems, for example. Keeping these permissions would require the rights issuer to be able to re-sign using the original certificate (which would typically belong to the publisher of the application), which is unlikely to be acceptable.
It is more common for components requiring rights to use a rule which evaluates another ruleset in a separate component, a “rights component”.

### 4.1 Rights Components

This rights component is referred to using an interface (defined by the publisher of the component requiring the rights). The ruleset name is also chosen by the component publisher; typically it includes the vendor name and application name, to reduce potential namespace conflicts.

The rights issuer can then simply generate a rights component implementing that interface (usually with a component name in a URI namespace owned by the rights issuer), and providing a definition of the relevant ruleset using whatever constraints are appropriate according to how the user has purchased the component rights (for example, this may be restricted to one device, several devices, it may have time, usage or date-range limitations to provide subscription capabilities, etc).

If a rights component expires due to either a “consumable right” being used up (such as a limited number of uses or a limited amount of time) or a date-range being exceeded, a new rights component can simply be acquired without requiring any changes to the component to which the rights component relates.

### 4.2 Rights Components Supporting Multiple Applications

As described above, components can implement several interfaces and provide multiple rulesets.

This allows a single rights component to provide rights for several different components as shown in FIG. 2. This means that a rights issuer can provide rights for groups of applications. One example of the use of this feature would be if the rights issuer provided a rights component enabling use of a group of puzzle games, on a subscription basis (perhaps expiring after 1 month).

### 4.3 Multiple Implementations of a Rights Component

Rights components are referred to using an interface, and there may be several different components which implement that interface.

When the software environment evaluates references to rulesets, it enumerates all components implementing the relevant interface, and evaluates the specified ruleset within each of them. The least restrictive implementation is chosen.

For example, where you have a rights component which implements several interfaces and rulesets for a number of puzzle games, and provides rulesets which expire after a certain date (as described in the example in section 4.2), it is possible that the user has also purchased a full (non-expiring) rights component for one of the games within that group.

When the user attempts to play that particular game, the software environment evaluating the rights will choose the least restrictive implementation of that game's interface and ruleset, which will be the one providing full (non-expiring) rights. When the user attempts to play any other game in the set of puzzle games covered by the subscription rights component, there is only one implementation of the corresponding interface and ruleset available, and so the subscription (expiring) rights will be chosen.

FIG. 3 shows an example of a system with multiple rights components.

4.4 Default Component Behaviour without Rights

The author of a component requiring rights can control the behaviour of the software environment in situations where a valid rights component is not available in a number of ways.

This situation typically arises in Try-Before-You-Buy scenarios (either when the user downloads directly from a store to try the component, or when one user beams the component to another), or when purchased but date-restricted rights expire.

### 4.4.1 Specifying Default Behaviour in the Manifest

Although most of the rights rules corresponding to a particular component generally exist in a rights component generated separately from the component that it applies to, it is also valid for a component to contain certain other rules which control how the software environment should behave when all implementations of the external rights component evaluate to “false” or when none are present.

Typically, the rules used in this situation are ones which allow a limited amount of use of the component, either a limited number of uses of the component, a limited amount of time using it, or a limited amount of wall-clock time passed since the component was installed (regardless of whether it was being used).

These “consumable rights” are tracked securely by the software environment, such that when they are used up, the application no longer runs, or the software environment prompts the user to acquire additional rights.

### 4.4.2 Specifying Default Behaviour Programmatically

If a component contains executable code, it can control the DRM system in certain ways programmatically.

Application software can control when the DRM rights are evaluated, and modify its functionality according to the result. This means that games, for example, may allow the user to play the first level and then restrict access to further levels to devices which have a valid rights component, or applications might allow themselves to be used but not allow the results to be saved, etc.

Application software can also define when a “consumable right” has is judged to have been consumed (as interpreted by limited-use or limited-time rules), rather than relying on a generic concept of when a consumable right has been used imposed by the DRM software environment.

For example in the case of a game, the game author may decide that time spent viewing splash-screens and menus does not count toward the consumption of time, and that the user is not considered to have consumed a “play” until they actually enter the main part of the game. A DRM system where the consumption of these rights is automatically handled by the software environment without interaction with the application software cannot provide the same level of control.

In addition, an application which is using the DRM system programmatically in this way can receive a software event when rights expire, allowing it to adjust its behaviour as appropriate for the type of application. For example, a game might allow you to finish the level but not let you start a new one. Other types of application might immediately exit with a warning that your rights have expired.

Application software can also use these techniques to adjust its behaviour when using asset components (such as “level packs” for a game) for which rights are not available—perhaps allowing a limited amount of use of them.

### 4.4.3 Using Both Methods

One of the most flexible and user-friendly approaches to controlling default behaviour is to use a combination of the two approaches—allowing the user to control when rights are evaluated and consumed, and also taking advantage of the secure tracking of “consumable rights” usage by the underlying software environment.

This allows the application to provide an in-application user-interface for the user to acquire additional rights, which gives the feeling of a more integrated application/rights experience.

### 4.5 Rights Expiry

When a rights component expires or is not valid for some other reason, it can be used to determine where to acquire additional rights.

The “AGC-Issuer-URL” manifest header in a rights component contains a URL. Since the rights component is both specific to a particular component (or group of components) and the store from which the rights component was purchased, this URL can direct the user to precisely the correct web-page for purchasing additional rights, renewing subscriptions, etc. (subject to user authentication).

When the user attempts to use a component for which rights are not available, the software environment or the software application (in the case of a DRM-aware application component) can offer the user the option to launch the platform's web-browser to go to the URL specified in the expired/invalid rights component.

If no rights component is available from which an issuer URL can be determined, a default store web page can be displayed instead

4.6 Try-Before-You-Buy Downloading from a Store

In the case of a Try-Before-You-Buy download from a store, the store website generates a “dummy rights component” and the ATX file that the user downloads is one which contains both this dummy rights component and the component to which it applies.

The dummy rights component is one which does not confer any rights—its ruleset can never evaluate to “true”. However, it contains a valid “AGC-Issuer-URL” manifest header which when launched directs the user back to the correct page for purchasing valid rights.

Compared with a scenario where the user has to manually find the correct page on the store to purchase rights, this reduces the complexity of the acquisition of new rights, and therefore improves the ratio of users who complete the rights acquisition process.

### 4.7 Application Beaming

Beaming of content between end-users (super-distribution) is encouraged under this DRM model.

The beaming may be done using Bluetooth between mobile phones or PCs, over an infra-red or WiFi link, over email, or over many other transport mechanisms.

The package that is beamed is an ATX file containing a rights component and the subject component. The rights component that is beamed may be a dummy rights component downloaded from a store in a Try-Before-You-Buy operation, or a full valid rights component purchased by the sender.

Since a purchased rights component is locked to the purchaser's device, its ruleset does not evaluate to “true” on the recipient's device. However it is still useful as it contains the “AGC-Issuer-URL” manifest header which can be used to acquire rights. A dummy rights component can be used in the same way after beaming. In this model, a Try-Before-You-Buy application can be widely distributed, with any or all of the recipients able to return to the store to purchase rights, thus increasing the overall number of rights purchases compared with a system where content cannot be super-distributed.

### 5. USAGE SCENARIOS

### 5.1 Rights Checking, Consumption and Expiry Use-Cases

Certain operations must be performed in order for the DRM system to work correctly.
Checking whether rights are available, and take appropriate action if not
Recording the number of uses of applications and the amount of time for which they are used
Handling of rights expiry events (checking whether new rights are available and taking appropriate action if not)

These operations can be done either by the game or the software environment. Several uses-cases are described below.

### 5.1.1 Software Environment Automatically Handles Rights Checking, Consumption and Expiry

This scenario applies where the application has not been written to take advantage of the DRM capabilities described in this document. Such applications can still be used in conjunction with this DRM system, but with less functionality available in trial mode than would be the case in a DRM-aware application.

In this scenario (see FIG. 4), the software environment evaluates whether rights are available before starting the application. If rights are not available, the application will not be started.

### 5.1.2 Application Handles Rights Checking, Consumption and Expiry

### Example 1: Limited Levels Trial Mode

If an application has been written with knowledge of this DRM system in mind, the behaviour of the DRM system can be customised to provide a more user-friendly experience.

The application must perform the actions described above, but there is a certain amount of flexibility about when it can choose to do them.

FIG. 5 shows a game which allows the first level to be played, but which will not allow the user to proceed beyond that level without rights being available.

### 5.1.3 Application Handles Rights Checking, Consumption and Expiry

### Example 2: Limited Time Trial Mode

FIG. 6 shows a game which allows itself to be used for 1 minute of (not including the time spent navigating menus) if rights are not available.

### 5.1.4 Application Handles Rights Checking, Consumption and Expiry

### Example 3: Limited Functionality

FIG. 7 shows a game which only allows itself to be played while connected in multi-player mode to another instance of the game where valid rights are available on the other device.

The details of the consumable-rights consumption, rights-expiry event handling and offering the user the option to go to the store to purchase rights are not shown in this example for simplicity—they are assumed to be handled in a similar way to the previous examples.

### 5.2 Rights Acquisition Use-Cases

Several scenarios for acquiring rights are described below.

### 5.2.1 Manual User Navigation

The simplest but least satisfactory way in which a user can acquire rights is by manually navigating to the relevant page on a store website.

This is unsatisfactory because it is typically necessary for the user to log in to the site, find the relevant game, etc, which is a potentially long series of steps.

### 5.2.2 Automatic Redirection from within Application

A much better scenario (see FIG. 8) is possible when a game has been installed along with a rights component from the relevant store website, as rights components have in their manifest a URL specifying where to go to get additional rights.

The rights component installed does not necessarily have to be valid in order to be useful—it could be a valid rights component which has been beamed from another user of the application (in which case it will be locked to that user's device and so won't be valid on the recipient's device), it could be a valid but expired rights component for the user's device, or it could even be a dummy rights component generated by the store solely for the purpose of carrying this issuer URL information—in this case the rights component would never be valid on any device.

Regardless of the origin and validity of the rights component, the issuer URL can be determined from the manifest, and a web-browser can be launched going directly to the precise page from which the user can get rights.

In addition, if the store website generated the URL in an appropriate way, various pieces of information about the user's device (such as its unique ID) can be automatically inserted into the URL before the web-browser is invoked. This allows the store website to automatically determine the identity of the user, thus bypassing another step. Note: this is purely used for identification—it is not an authentication mechanism and does not provide any security. Some other authentication mechanism must be used, such as a password or some form of automatic network-operator authentication.

### 5.2.3 In-Application Rights Acquisition

A third option for rights acquisition which also makes use of the issuer URL encoded in the manifest of a rights component is in-application rights acquisition, where instead of launching a web browser to process the transaction, the application itself communicates with some network service to acquire rights, as shown in FIG. 9.

Web services based on XML and HTTPS are commonly used for this sort of operation—a library can be provided which gives the application a relatively simple API for initiating and processing such a transaction.

The same basic steps are required as for a web-browser based transaction however, but in this case the application must provide the user-interface for user authentication, displaying the cost, getting confirmation from the user, selecting a billing method, etc. This requires a significant amount of user-interface support in the application, but it can provide a more user-friendly experience.

### 5.3 Rights Issuer Use-Cases

The rights issuer offers the user various options and then issues rights based on certain parameters of the application, such as whether it is DRM-aware or not, whether the publisher wishes to allow subscription or grouped rights, etc.

### 5.3.1 Dummy Rights

A dummy rights component is typically issued for a try-before-you-buy scenario where the application is DRM-aware, as shown in FIG. 10.

The sole purpose of such a rights component is to assist in subsequent rights purchases by providing an issuer URL, and never provides valid rights under any circumstances.

### 5.3.2 Limited-Use Rights

These can be issued to provide a try-before-you-buy behaviour for non-DRM-aware applications. The software framework will evaluate the validity of the rights and either allow the application to run or prevent it, as shown in FIG. 11.

The rights issuer can issue a time-limited or usage-limited rights component.

### 5.3.3 Subscription Rights

The rights issuer can generate a rights component which expires at a specified date and time, as shown in FIG. 12. This can be used to provide a subscription rights system—once the rights expire, the user is prompted to return to the store to purchase additional rights.

These rights are typically locked to a particular set of devices using the unique IDs, but it may also be used as an alternate form of try-before-you-buy without being device-constrained.

### 5.3.4 Device-locked Rights

The rights issuer can generate a rights component which has no usage constraints other than the set of devices on which it is valid. This equates to a full, unlimited purchase of the rights to use an application. These rights components will be locked to a specific set of devices using the relevant unique IDs.

FIG. 13 demonstrates how if such a rights component is transferred to a device which is not one of the ones specified in the rights ruleset, the rights are not valid on that device and so the application reverts to trial mode.

### 5.3.5 Manufacturer or Operator Locking

The rights issuer can produce a rights component which will be valid only on devices made by a particular manufacturer, on a particular mobile phone network or on a particular device type or set of device types, as shown in FIG. 14.

This can be used to provide exclusive application releases locked to a particular set of client devices, while still allowing the applications to be freely beamed between devices. This can be used in conjunction with any of the other use-cases described in this section, such as subscriptions or try-before-you-buy rights.

This could also be used in conjunction with other date-related rules in the ruleset to provide operator or manufacturer exclusivity of a game for the first month (for example) of its release, after which it would automatically become usable on other devices.

### 5.3.6 Rights Packs for Multiple Applications

The rights issuer specifies in the rights component manifest what interface names and ruleset names are supported. Since a component can implement several interfaces and rulesets, this allows the rights issuer the opportunity to generate a rights component which provides valid rights for multiple applications.

This could be used to provide a “puzzle games” subscription, for example, where a set of games (determined by the rights issuer) would be valid while the rights component was valid.

### 5.3.7 Rights for Multiple Applications

An additional use-case for having a single rights component providing rights for multiple applications stems from the fact that the rights issuer can choose to provide different rights rulesets for the different applications, perhaps providing a limited period of validity for one application when the full rights for another application are purchases, as a free bonus for the user. An example is illustrated in FIG. 15.

### 5.4 Distribution Use-Cases

There are a number of distribution use-cases for application components. However, these can be categorized into three main areas.

### 5.4.1 Download from Store

The content is downloaded directly from a store. This may be a purchase (outright or subscription) or it may be a try-before-you-buy scenario.

### 5.4.2 Physical Media

The content is distributed on a physical medium such as a CDROM or flash card. Examples of this include distribution of media through a physical store and distribution through magazine cover disks.

The user gets a content package containing the application component and a dummy rights component whose issuer URL is set to direct the user to the store in the event that the user chooses to purchase.

### 5.4.3 Viral (User to User) Distribution

In this use-case, the content is transferred from one user to another. This may take place across any communication medium, including e-mail, instant-messaging, Bluetooth, flash memory, etc.

The rights component which was originally generated by the store for the user who initially downloaded the content is transferred in the content package. If the rights component is device-locked (which it is if the user has acquired it through a purchase rather than a try-before-you-buy), the rights are not valid on the receiving device.

However, whether they are valid or not the presence of the rights component enables the recipient to go directly to the issuer URL encoded in the rights component if they choose to purchase the content. FIG. 16 shows an example.

The store may choose to encode information in this URL about the identity of the original purchaser, which would allow them to give that person some kind of reward for referred purchases (store credit, for example).

Note that the content package may be transferred a number of times between different users, before eventually one or more of them decides to purchase rights.

An important feature of this scenario is that when combined with the binary-portability of the executable code across different CPUs and operating-systems, the viral distribution can take place across a much wider range of devices than is typically the case with traditional executable code.

Another important feature is that this distribution mechanism can apply to any component—for example it can apply to asset components such as game levels as well as application components (the game itself).

1. A method of distributing rights-managed software comprising delivering to a first user a binary-portable application component including unencrypted executable code and an associated rights component defining cryptographically-signed licence conditions for unrestricted execution of the application by the first user, whereby on the first user copying the application component to a second user, the application component when executed by the second user checks for the presence of a rights component and runs in restricted mode if a rights component is missing or if the rights component determines that the licence conditions are not satisfied in respect of the second user.

2. A method as claimed in claim 1 including delivering to the second user, on request, a fresh rights component defining licence conditions which allow the second user unrestricted execution of the copy of the application component that was received from the first user.

3. A method as claimed in claim 1 in which a single rights component defines the licence conditions for a plurality of application components.

4. A method as claimed in claim 1 including multiple rights components, the respective licence conditions of each being checked to determine whether the application component will run in unrestricted mode.

5. A method as claimed in claim 4 in which execution of the application component is determined by the least restrictive of the respective licence conditions.

6. A method as claimed in claim 1 including a plurality of application components and a plurality of rights components, each application component, when executed, checking the respective licence conditions of the rights components, and executing in a mode which is determined by the least restrictive of the said conditions.

7. A method as claimed in claim 1 in which the application component executes in a first restricted mode if it determines that a rights component is not present and in a second restricted mode if a licence component is present but the respective licence conditions are not satisfied.

8. A method as claimed in claim 1 in which the restricted mode includes a time or use limitation, at the expiry of which the application can no longer be executed.

9. A method as claimed in claim 8 in which the expiry is determined programmatically by the application component.

10. A method as claimed in claim 8 in which, following said expiry, the second user is directed, or given the option to be directed, to an online location at which a fresh rights component may be purchased.

11. A method as claimed in claim 10 in which the online location is a URL stored within the application component.

12. A method as claimed in claim 10 in which the online location is a URL stored within the rights component.

13. A method as claimed in claim 1 in which the rights component delivered to the first user is a dummy rights component in which the licence conditions can never be satisfied, allowing the first user to try the application component in restricted mode before deciding whether to purchase a rights component allowing unrestricted execution.

14. A method as claimed in claim 1 in which the licence conditions for the rights component supplied to the first user require the application component to be executed on a specific device so that, if the application component and the rights component are copied to a different device, the application component will execute in the restricted mode.

15. A method as claimed in claim 1 in which the application component is a game for a mobile phone.

16. A computer-readable media storing program code for implementing on a digital computer the method of claim 1.
